(19) United States
(12) Patent Application Publication
(10) Pub. No.: US 2020/0393186 A1
(43) Pub. Date: Dec. 17, 2020

(54) ENVIRONMENTAL CONTROL SYSTEM AND METHOD FOR OPERATING SAME

(71) Applicant: Panasonic Intellectual Property Management Go,, Ltd., Osaka (JP)

(72) Inventors: Shin'ichi HORII, Shiga (JP); YUi KOASHi, Kyoto (JP)

(21) Appl. No.: 16/975,665

(22) PCT Filed: Jan. 28, 2019
(86) PCT No.: PCT/JP2019/002727

§ 371 Date: Aug. 25, 2020

(30) Foreign Application Priority Data
Feb. 26, 2018 (JP) 2018-032219

(51) Int. Cl. F25D 11/00; B60P 3/20; F25D 29/00

(52) U.S. Cl. CPC F25D 11/003; B60P 3/20; F25D 2700/12; F25D 2201/12; F25D 29/003

(57) ABSTRACT

An environmental control system includes: a plurality of containers that stores goods; a shelf that accommodates the plurality of containers; an environmental adjustment facility that adjusts the environment in each container; and a control unit. The control unit controls the environmental adjustment facility so that the environment in the container is adjusted to a predetermined environmental range based on attributes set for each container.

### TECHNICAL FIELD

The present disclosure relates to environmental control systems that hold an article in a predetermined state and methods of operating the same.

### BACKGROUND ART

Patent Document 1 describes a control device for a vehicle having a temperature-controllable container mounted on a vehicle body. Patent Document 1 also describes that a plurality of carts each equipped with a refrigerating and freezing unit is accommodated in the container.

### CITATION LIST

### Patent Documents

PATENT DOCUMENT 1: Japanese Unexamined Patent Publication No. 2017-119493

### SUMMARY OF THE INVENTION

### Technical Problem

An environmental control system is provided which adjusts each container to its desirable environmental range based on attributes of the container.

### Solution to the Problem

An environmental control system of the present disclosure includes: a plurality of containers that stores goods; a shelf that accommodates the plurality of containers; an environmental adjustment facility that adjusts an environment in each container; and a control unit that controls the environmental adjustment facility so that the environment in the container is adjusted to a predetermined environmental range based on an attribute set for each container.

A method for operating an environmental control system according to the present disclosure is a method for operating an environmental control system including a plurality of containers that stores goods, a shelf that accommodates the plurality of containers, and an environmental adjustment facility that adjusts an environment in each container, including: controlling the environmental adjustment facility by a control unit so that the environment in the container is adjusted to a predetermined environmental range based on an attribute set for each container.

### Advantages of the Invention

The environmental control system of the present disclosure can adjust each container to its desirable environmental range based on attributes of the container.

### BRIEF DESCRIPTION OF THE DRAWINGS

FIG. 1 illustrates an exemplary environmental control system according to an embodiment of the present disclosure.

FIG. 2 is a side view illustrating a configuration example of a shelf and containers in the environmental control system.

FIG. 3 is a top view illustrating a part of the configuration of the shelf shown in FIG. 2.

FIG. 4 illustrates air flow into each container in the shelf shown in FIG. 2.

FIG. 5 illustrates the container in FIG. 4.

FIG. 6 illustrates other configuration examples of the container in the present disclosure.

FIG. 7 illustrates another configuration example of the shelf in the present disclosure.

FIG. 8 illustrates determination of the environmental range for each container.

FIG. 9 illustrates an example of a process of determining the environmental range according to attributes of the container.

FIG. 10 illustrates another example of the process of determining the environmental range according to the attributes of the container.

FIG. 11 illustrates still another example of the process of determining the environmental range according to the attributes of the container.

FIG. 12 illustrates a further example of the process of determining the environmental range according to the attributes of the container.

### DESCRIPTION OF EMBODIMENTS

(Knowledge on Which the Present Disclosure Is Based etc.)

In recent years, with the spread of the information and communication technology (ICT), the needs for physical distribution have been increasing globally, and shortage of manpower involved in transportation of goods has become a social problem. Especially, the demand for distribution of goods that require temperature control such as fresh food, medicines, and refrigerated and frozen goods is growing, and it is desired to transport goods of different temperature zones simultaneously and efficiently.

In this regard, a temperature-controllable container is mounted on a vehicle body, and a plurality of carts each equipped with a refrigerating and freezing unit is accommodated in each container.

However, the cost for the carts equipped with the refrigerating and freezing unit tends to be higher than that for carts for room temperature because the carts equipped with the refrigerating and freezing unit require a compressor etc. Moreover, each of the carts need to have a cooling system, which further increases the cost and size of the carts. When using the large carts, there will be a large empty space in a situation where the vehicle body is moved with the carts empty after transportation. This significantly reduces efficiency.

A controlled object is not limited to temperature. Humidity, gas (type and concentration of gas such as carbon dioxide or oxygen), light (illuminance, wavelength and its distribution, etc.), sound (frequency, magnitude), vibration, etc. may also be individually controlled to a predetermined environmental range.

### Embodiment

In view of the above, an embodiment of the present disclosure will be described with reference to the drawings.

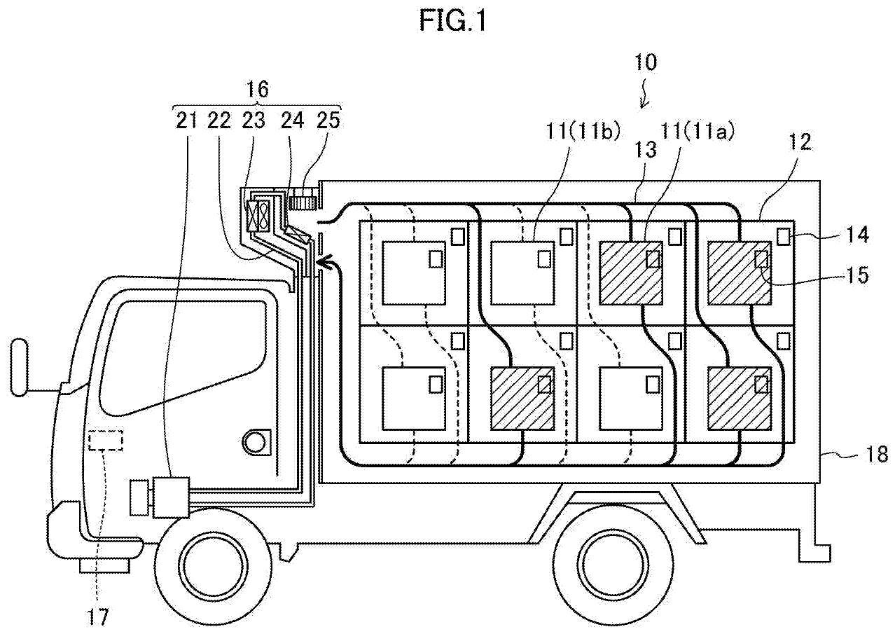

FIG. 1 schematically illustrates an exemplary environmental control system 10 of the present embodiment. The environmental control system 10 is mounted on a vehicle 18 and is used for transporting goods while controlling the environment. The environmental control system 10 includes a plurality of containers 11 for storing goods and a shelf 12 for accommodating these containers. The environmental control system 10 further includes an environmental adjustment facility that adjusts the environment in each container 11.

The environmental adjustment facility can be operated by electric power that is supplied from an engine and/or a secondary battery of the vehicle. The secondary battery may be a battery for an xEV vehicle, that is, a battery electric vehicle (BEV), a hybrid electric vehicle (HEV), a plug-in hybrid electric vehicle (PHEV), etc. or may be a separate battery for environmental adjustment. Although the containers 11 can be of various sizes, the containers 11 may be large enough to hold about one package with a sum of length, width, and height of 160 cm, which is a typical maximum size for individual home delivery, or may be large enough to hold about 10 packages of the individual home delivery size which correspond to the amount of delivery for a single apartment house, a single small shop, etc.

In the present embodiment, the environmental adjustment facility includes a refrigerator 16, an air flow path 13 through which air cooled by the refrigerator 16, namely a medium, flows into each container 11, and a contact adjustment unit (not shown in FIG. 1) that adjusts the degree of contact of the air as a medium with the inside of each container 11. This environmental adjustment facility adjusts the temperature zone such as room temperature, refrigeration, or freezing as the environmental range of each container 11.

Each container 11 includes a recording unit 15 that stores attributes of each container 11. The recording unit 15 is, e.g., a two-dimensional barcode, a QR code (registered trademark, the same applies hereinafter), an IC tag, an RFID, etc. The shelf 12 includes recognition units 14 that recognize the attributes of each container 11 accommodated in the shelf 12. The recognition unit 14 may be a reader that reads the attributes of the corresponding container 11 from the recording unit 15.

The attributes includes at least information from which an environment suitable for preservation, storage, and transportation of the contents in the container 11 can be determined. This information is, e.g., information indicating whether the contents in the container 11 are frozen goods, refrigerated goods, or room temperature goods. The attributes may further include information on the origin and the delivery destination and information on the departure and arrival times. In the case where the container 11 contains a plurality of types of contents, the attributes may include information corresponding to the contents of each type or may be a single piece of information from which an environment suitable for preservation, storage, and transportation, which is common to all of the contents or is harshest out of the contents, can be determined.

The environmental control system 10 further includes a control unit 17 that controls the environmental adjustment facility and the recognition units 14. The recognition unit 14 reads the attributes from the recording unit 15 when the container 11 is loaded and/or in response to a control signal from the control unit 17 which instructs the recognition unit 14 to read the attributes. For example, the recognition unit 14 may read the attributes from the recording unit 15 by transmitting radio waves to the recording unit 15 and receiving reflected waves carrying information.

The refrigerator 16 includes a compressor 21, a refrigerant pipe 22, a condenser 23, an evaporator 24, and a fan 25. The compressor 21 compresses a refrigerant into a high-temperature, high pressure gaseous refrigerant and sends the high temperature, high pressure gaseous refrigerant to the condenser 23 through the refrigerant pipe 22. The condenser 23 cools the high temperature, high pressure gaseous refrigerant from the compressor 21 with outside air to liquefy the gaseous refrigerant. The evaporator 24 vaporizes the liquid refrigerant from the condenser 23 to remove heat from the surroundings and cool air. The fan 25 forces the cooled air, which is a medium, to circulate in the air flow path 13.

The air as a medium thus cooled by the refrigerator 16 flows through the air flow path 13 into each container 11. At this time, the temperature zone in the container 11 can be adjusted by adjusting the amount of contact between the container 11 and the air, that is, the amount of air flowing in the container 11. In order to adjust this amount of contact, the control unit 17 controls the contact adjustment unit for each container 11 based on the attribute of the container 11.

Containers 11a shown shaded in FIG. 1 are containers that are adjusted to a freezing temperature (e.g., −40 to −15° C.), and a relatively large amount of air flows through the air flow path 13, shown by solid lines, into the containers 11a. Containers 11b shown unshaded in FIG. 1 are containers that are adjusted to a refrigeration temperature (e.g., −5 to 5° C.), and a relatively small amount of air flows through the air flow path 13, shown by dashed lines, into the containers 11b. There may be a container(s) that is adjusted to room temperature (e.g., 10 to 20° C.). In this case, a smaller amount of air may flow through the air flow path 13 into the container(s) or no air may be allowed to flow through the air flow path 13 into the container(s). The contact adjustment unit also adjusts the amount of air that flows into each container 11 according to its desirable temperature zone. The amount of contact of the air is also determined depending on the environment (air temperature etc.) where the shelf 12 is mounted.

The environmental range (temperature zone) that is adjusted in each container 11 is determined based on the attributes of each container 11. The attributes may be information stored in the recording unit 15 or may be information separately managed by a list etc. When setting the environmental range (temperature zone) based on the attributes stored in the recording unit 15, the recognition unit 14 recognizes the information on the corresponding container 11 and determines the environmental range (temperature zone) for the container 11 based on the recognized information.

<Configuration Example of Shelf and Containers>

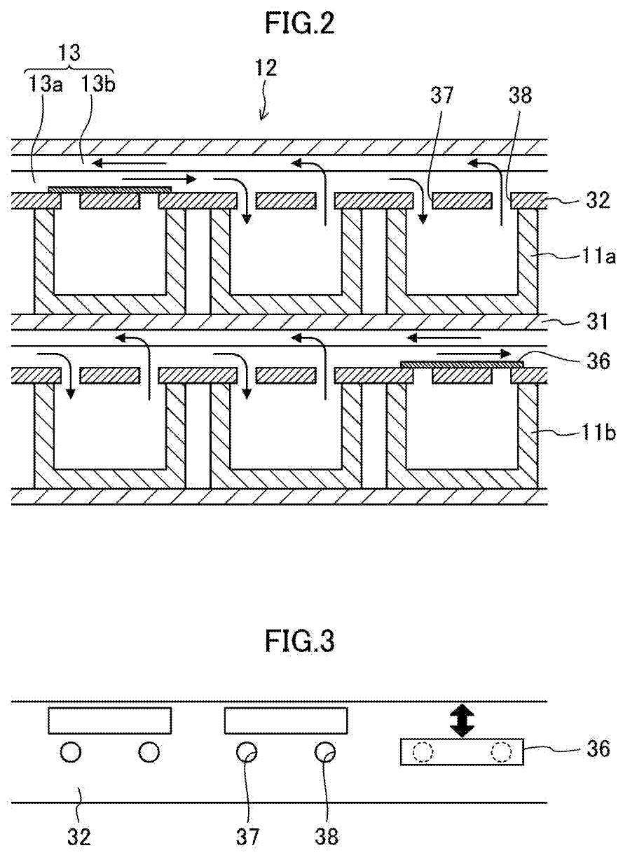

FIGS. 2 and 3 schematically illustrate the contact adjustment unit that adjusts the amount of contact of each container 11 with air as a medium cooled by the refrigerator 16.

FIG. 2 schematically illustrates the containers 11 accommodated in the shelf 12 as viewed from the side.

In this example, the containers 11 are open at the top. This may be considered as the containers 11 with their lids removed.

The shelf 12 includes a platform portion 31 on which the containers 11 are placed and a top portion 32 located over the containers 11 placed on the platform portion 31. The shelf 12 has a plurality of tiers for accommodating the containers 11. The air flow path 13, which is a part of the environmental adjustment facility, is located between the platform portion 31 and the top portion 32 of the tier below the platform portion 31. More specifically, a cooling flow path 13a through which air cooled and sent by the refrigerator 16 flows and a return flow path 13b through which air returning to the refrigerator 16 flows are located between the platform portion 31 and the top portion 32 of the tier below the platform portion 31. The top portion 32 has inlet holes 37 and outlet holes 38 at positions above each container 11. Air flows from the cooling flow path 13a into the containers 11 through the inlet holes 37, and the air flows out of the containers 11 into the return flow path 13b through the outlet holes 38. The shelf 12 further includes opening and closing plates 36 each capable of partially or entirely closing the inlet hole 37 and the outlet hole 38.

FIG. 3 schematically illustrates a part of the configuration of FIG. 2 as viewed from above. Specifically, FIG. 3 illustrates the top portion 32, the inlet holes 37 and the outlet holes 38 in the top portion 32, and the opening and closing plates 36.

As described above, the amount of air flowing in the container 11 and contacting the container 11 can be adjusted by moving the opening and closing plate 36 to open or close or partially close the inlet hole 37 and the outlet hole 38. That is, the inlet hole 37, the outlet hole 38, and the opening and closing plate 36 function as the contact adjustment unit. The temperature zone such as freezing, refrigeration, or room temperature can thus be set as an example of the environmental range of the container 11.

The opening and closing plate 36 also serves to close the inlet hole 37 and the outlet hole 38 at a position where the container 11 is not accommodated. This prevents cold air from flowing from the cooling flow path 13a into an unnecessary area and thus achieves energy saving.

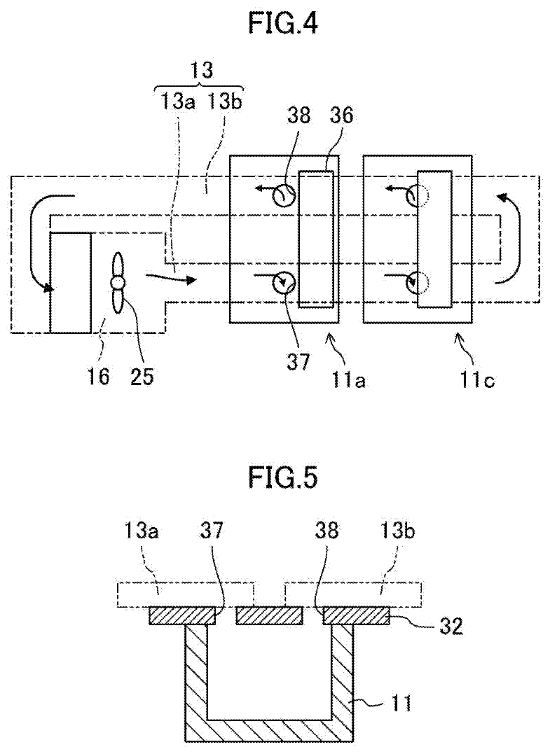

FIGS. 4 and 5 are schematic top and side views further illustrating the environmental adjustment facility that causes air as a medium to flow into each container 11. In FIG. 4, the inlet hole 37 and the outlet hole 38 of the container 11a are not closed at all by the opening and closing plate 36 provided above the container 11a. On the other hand, the inlet hole 37 and the outlet hole 38 of the container 11c are half closed by the opening and closing plate 36.

The fan 25 of the refrigerator 16 sends cold air into the cooling flow path 13a. For the container 11a, the cold air flows through the inlet hole 37 in the top portion 32 into the container 11a. The container 11a is thus cooled. The air then flows out of the container 11a into the return flow path 13b through the outlet hole 38 and returns to the refrigerator 16, where the air is cooled again. Since the inlet hole 37 and the outlet hole 38 of the container 11c are approximately half closed by the opening and closing plate 36, a smaller amount of air flows through the container 11c as compared to the container 11a. The container 11c is thus held in a higher temperature zone than the container 11a. For example, the container 11a has a freezing temperature, and the container 11c has a refrigeration temperature.

Although not shown in the figures, in the case where the inlet hole 37 and the outlet hole 38 are completely closed by the opening and closing plate 36, no air flows from the air flow path 13 into the container 11 and the container 11 is not cooled. This is, e.g., the case where the container 11 is set to room temperature. However, for example, in the case where the ambient temperature is high, the container 11 may be cooled to some extent in order to set the container 11 to room temperature.

<Other Configuration Examples of Shelf and Containers>

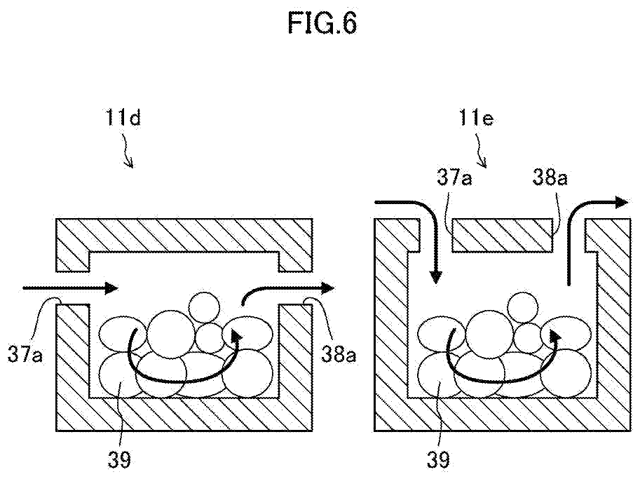

FIG. 6 illustrates other configurations of the container. FIGS. 2 to 5 illustrate an example in which the containers are open at the top. However, the present disclosure is not limited to this. As shown in FIG. 6, the container may be a box that is not open at the top (or a box with a lid on) and may also have an inlet hole 37a and an outlet hole 38a. A container 11d shown in FIG. 6 has the inlet hole 37a and the outlet hole 38a in the upper parts of its opposing side walls. A container 11e shown in FIG. 6 has the inlet hole 37a and the outlet hole 38a in its upper surface (or lid).

It is desirable that the container 11 have the inlet hole 37a and the outlet hole 38a in its upper part. Since goods such as foodstuffs 39 are placed in the container 11, air is circulated in the upper part of the container 11 which is relatively empty. Since cold air accumulates at the bottom, it is easy to make the temperature in the container uniform. It is therefore suitable that the container have the inlet hole 37a and the outlet hole 38a in its upper surface like the container 11e, and it is suitable that the container have the inlet hole 37a and the outlet hole 38a in the upper parts of its side walls like the container 11d. The container 11 is suitably made of a thermally insulating material. For example, the container 11 may be a box made of expanded polystyrene foam. The shelf 12 may also be configured to provide thermal insulation between the containers 11 and/or between the container 11 and its surrounding environment. In the environmental control system 10 of the present disclosure, adjacent ones of the containers 11 are often controlled to different temperature zones, and it is therefore suitable to thermally insulate the containers 11 from each other so that the containers 11 are less likely to affect each other. It is also suitable to provide thermal insulation between the container 11 and its surrounding space (in the present embodiment, in the vehicle 18) where the environmental control system 10 is installed. For example, the containers 11 can thus be controlled to the freezing temperature or the refrigeration temperature while keeping the surrounding space (in the present embodiment, in the vehicle 18) where the environmental control system 10 is installed at room temperature. This reduces the burden on an operator who loads and unloads the containers 11 etc. Since only the containers 11 need be environmentally controlled, this configuration contributes to energy saving.

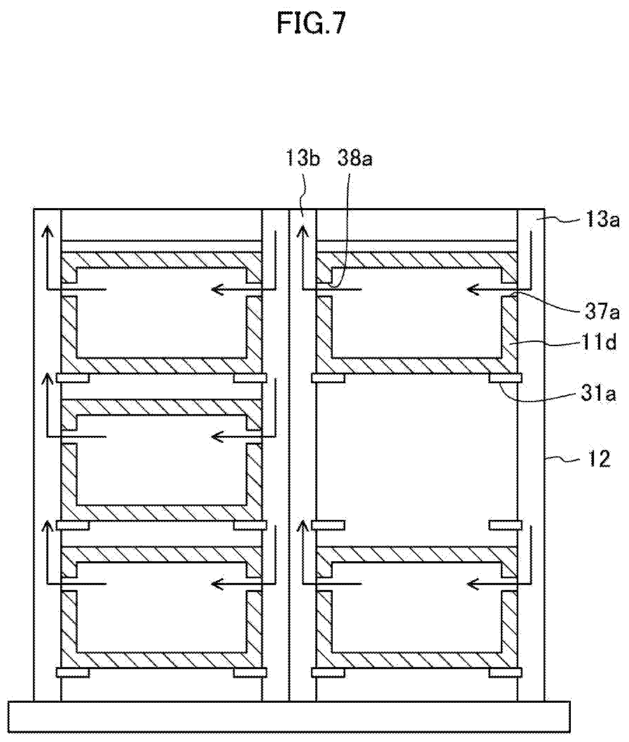

FIG. 7 schematically illustrates an example of the shelf 12 for the containers 11d of FIG. 6. In the shelf 12, the containers 11d are placed on platform portions 31a provided on the wall surfaces of the shelf 12. The cooling flow path 13a from which air flows into the containers 11 through the inlet holes 37a and the return flow path 13b into which air flows out of the containers 11d through the outlet holes 38a are located on the wall surfaces on both sides of the container 11.

Although not shown in the figures, this configuration also has an opening and closing mechanism in order to adjust the flow rate of air into the container 11d (the amount of contact between the container 11d and air). For example, the opening and closing mechanism may be a configuration that is similar to the opening and closing plate 36 of FIG. 3 and is provided on the wall surface of the shelf 12. Alternatively, the container 11d may have an opening and closing plate, and the shelf 12 may have a mechanism that operates the opening and closing plate.

Instead of the opening and closing plates 36, dampers may be disposed at appropriate positions in the air flow path 13, and the amount of air flowing into each container 11 may be adjusted by varying the opening and closing times of the dampers.

Each container 11 can be individually adjusted to a desirable temperature zone in a manner described above. The configuration using the refrigerator 16, the air flow path 13, the opening and closing plates 36, etc. is desirable because this configuration can relatively easily implement adjustment for each container 11. However, the present disclosure is not limited to this, and any configuration may be used as long as it can individually adjust the temperature zone of each container 11. For example, instead of the opening and closing plates 36 or the dampers, a configuration may be used in which opening and closing of a curtain or the extent to which an opening is opened is adjusted to change the amount of medium such as air. For example, the cooling temperature may be set for each container by using refrigerant pipes of a refrigerator which are disposed at each position of the containers 11 in the shelf 12 or by using a Peltier cooler etc. Although the cooling facility is described above, a heater may be provided in order to maintain a high temperature in the containers 11.

Examples of the environmental range other than the temperature zone include humidity, gas (type and/or concentration of gas such as oxygen), light, sound, and vibration. For example, the humidity in the container can be adjusted using a humidity controller that adjusts the air humidity instead of the refrigerator 16 of the embodiment. Similarly, the gas environment (oxygen concentration etc.) in the container can be adjusted using a filter, an adsorbent, a predetermined gas supply device, etc. An illumination for adjusting the illuminance and/or light wavelength in the container, a speaker for adjusting the frequency of sound or vibration, etc. may be provided. Two or more of these elements may be combined.

<Adjustment of Environmental Range for Each Container>

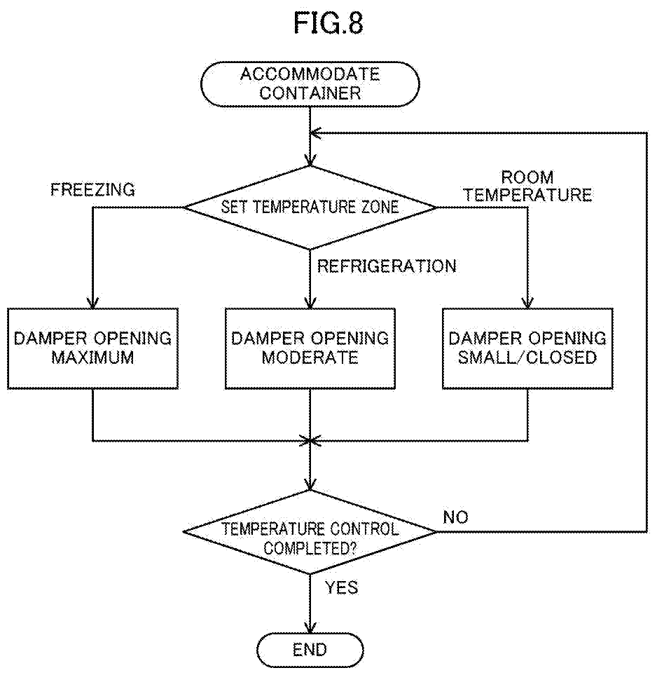

Next, setting of the temperature zone (an example of the environmental range) for each container 11 will be described. As shown in FIG. 8, when the container 11 is accommodated in the shelf 12, the environmental control system 10 illustrated in FIG. 1 determines a desirable temperature zone for the container 11. For example, for the container 11 to be set to the freezing temperature, the damper (such as the opening and closing plate 36 in FIG. 2) is opened to the maximum extent to maximize the amount of air flowing into the container 11. For the container 11 to be set to the refrigeration temperature, the damper is opened to a moderate extent to allow a moderate amount of air to flow into the container 11. For the container 11 to be set to room temperature, the damper is opened to a small degree to allow a small amount of air to flow into the container 11, or the damper is closed to prevent air from flowing into the container 11. If there is any other container 11 for which temperature control (setting of the temperature zone) is not completed after the extent to which the damper is opened is set for one container 11, the process returns to setting of the temperature zone for that container 11. Once temperature control is completed for all the containers 11, the process regarding temperature control of the containers 11 is finished.

When the temperature zone is adjusted by a refrigerant circuit, a Peltier cooler, etc., the flow rate of the refrigerant, the amount of electric power that is supplied to the Peltier cooler, etc. is set instead of the extent to which the damper is opened.

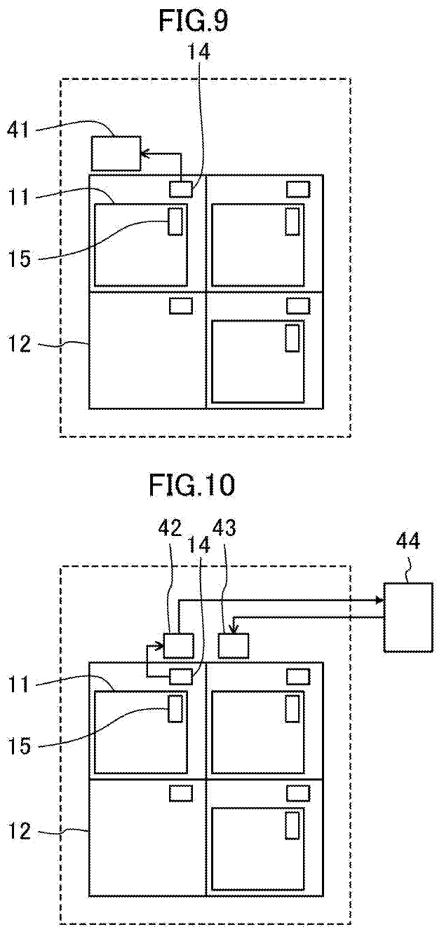

FIG. 9 illustrates determination of the environmental range (temperature zone) according to the attributes of the container 11. In FIG. 9, the containers 11 are accommodated in the shelf 12. Each container 11 has the recording unit 15 that stores the attributes of the container 11. The shelf 12 includes the recognition units 14 that recognize the attributes of the containers 11 and a determination unit 41 that determines the environmental range for each container 11.

The recognition unit 14 recognizes the attributes of the container 11 accommodated in the shelf 12 and reads the attributes stored in the recording unit 15 of this container 11.

Based on the recognized attributes, the determination unit 41 determines the environmental range to which the container 11 should be controlled. The environmental adjustment facility (including e.g., the refrigerator 16, the air flow path 13, the opening and closing plates 36, etc.) controls this container 11 to the determined environmental range.

By such a method, the environmental range can be determined based on the attributes of each container 11 without depending on the outside.

In FIG. 9, each container 11 is provided with the recognition unit 14. However, a handheld scanner may be used as the recognition unit 14, and the recording units 15 of the individual containers 11 may be sequentially read using the handheld scanner.

FIG. 10 illustrates another example of determination of the environmental range. In this example as well, the recognition unit 14 recognizes the attributes of the container 11. However, this configuration does not include the determination unit that determines the environmental range based on the attributes. Instead, this configuration includes a transmission unit 42 that sends the attributes to an external server 44 and a reception unit 43 that receives the environmental range from the external server 44.

The transmission unit 42 sends the attributes recognized by the recognition unit 14 to the external server 44, and the external server 44 determines the environmental range of the corresponding container 11 based on the attributes. The reception unit 43 receives the determined environmental range. The environmental control facility then controls the corresponding container 11 to the received environmental range.

It is not essential for this configuration to include the recognition units 14. In the case where the configuration does not include the recognition units 14, the recording units 15, for example, may directly send information to the external server 44 if the recording units 15 are active RFIDs etc. as the recording units 15 have a spontaneous communication function of about 1 to 100 m. In this case, a power supply etc. for the RFID may be provided for each container 11.

In this method, the external server 44 determines the environmental range according to the attributes. It is therefore possible to handle more diverse attributes. When adding a new type of attribute (and a corresponding environmental range), it is not necessary to add data to the determination unit 41 of each system, but the data need only be added to the external server 44.

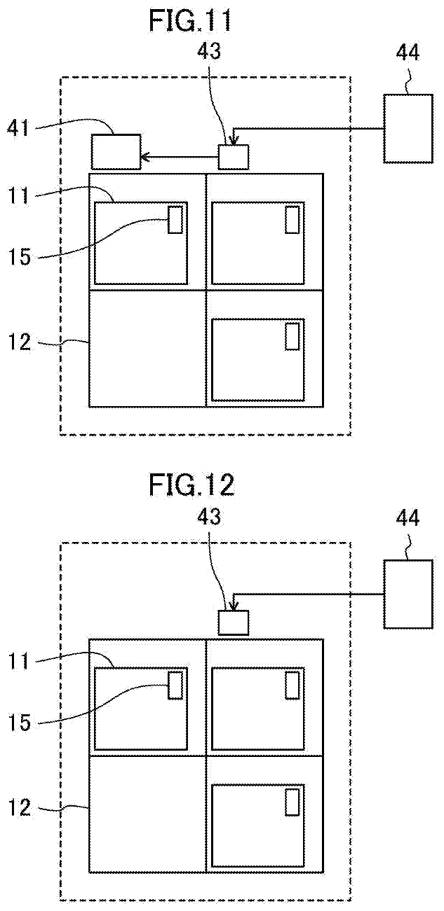

FIG. 11 illustrates still another example of determination of the environmental range. In this example, the environmental control system does not include the recognition units 14.

Instead, the reception unit 43 receives the attributes of the container 11 from the external server 44. The determination unit 41 then determines the environmental range of the corresponding container 11 based on the received attributes. Thereafter, the environmental control facility controls the corresponding container 11 to the determined environmental range.

The external server 44 may hold a list in which the positions where the containers 11 are accommodated are associated with their environmental ranges, and may send the attributes to the reception unit 43 based on the list. Alternatively, an external reader may be provided which reads the attributes from the recording unit 15 of each container 11 using a sensor or a reader, such as a camera, disposed outside the shelf 12, records the read attributes on the server 44, and sends them to the reception unit 43.

In this method, it is not necessary for the environmental control system to have the recognition units. This method is useful for simplifying the system and reducing the cost.

FIG. 12 illustrates a further example of determination of the environmental range. In this example, the environmental control system does not include the recognition units 14, the determination unit 41, etc. The environmental control system includes the reception unit 43, and the reception unit 43 receives the environmental range according to the attributes of the container 11 from the external server 44. The environmental control facility then controls the corresponding container 11 to the received environmental range. In this case as well, the environmental range is determined based on the attributes corresponding to each container 11 obtained from a list stored in advance, or based on the attributes read from a reader disposed outside the shelf 12.

In this method, the system is further simplified and the cost is further reduced as compared to the example of FIG. 11.

In addition to FIGS. 9 to 11, there are various other possible ways to recognize the attributes of the container 11 and determine the corresponding environmental range. The configurations and methods illustrated in FIGS. 9 to 11 may be combined. For example, in the case where a desirable environmental range is recorded as the attributes, this environmental range is used. In the case where only description of the contents is recorded, the description of the contents may be sent to the external server 44, and the determined environmental range may be received. The attributes of the container 11 will also be described later.

<Recording Unit and Recognition Unit>

Radio frequency identifier (RFID) technology may be used for the recording unit 15 and the recognition unit 14. That is, an RF tag or an IC tag is used as the recording unit 15, and the recognition unit 14 is a reader that reads the tag. Alternatively, a tag with a barcode, a QR code, etc. printed thereon may be attached as the recording unit 15, or a barcode, QR code, etc. may be directly printed on the container 11. Alternatively, a color(s) or character(s) that can also be recognized by humans may be provided as the recording unit 15, and the recognition unit 14 may recognize and detect the color(s) or character(s). Alternatively, the attributes may be recorded using the shape of the container 11 or a cutout(s), protrusion(s), etc. of the container 11 as the recording unit 15.

The transmission unit 42 and the reception unit 43 may be configured to communicate by wireless communication such as optical communication, Bluetooth (registered trademark) or Zigbee (registered trademark). Wireless communication in a frequency band of radio waves having high straightness is selected for the wireless communication. When using optical communication, a light receiving unit having directivity is used so that pieces of attribute information on neighboring containers will not be erroneously recognized.

The attributes stored in the recording unit 15 include, e.g., description of goods that are placed in the container 11, the environmental range to which the container 11 is to be adjusted, a unique identification number of the container 11, a temporary identification number of the container 11, and information on transportation of the container 11 (delivery destination, transit point, origin, distributor, intermediary, delivery date and time, delivery time, etc.). For example, the unique identification number is an identification number unique to each container 11. The temporary identification number is information that is externally rewritable for each delivery and that is used to indicate the position of the container 11 in the shelf 12 or the contents of the container 11.

As long as the attributes of the environmental range to which the container 11 is to be adjusted is stored in the recording unit 15, the control unit 17 can control the environmental range of the container 11 according to the attributes. In the case where description of goods or the identification number is stored, the environmental range may be determined by the determination unit 41 or the external server 44 as shown in FIGS. 9 to 11.

The information on transportation can also be used to, e.g., change the environmental range according to the transportation situation. For example, the container 11 being transported is set to a first temperature zone (e.g., freezing temperature) until first predetermined time (a certain amount of time before the time transportation is expected to complete) and is then set to a second temperature zone (e.g., refrigeration temperature) until second predetermined time (the time transportation is expected to complete). This is useful for adding more value to physical distribution such as transporting frozen sashimi (raw fish) from fishing ports to households in a good-to-eat condition while maintaining freshness. It is therefore possible to switch between transportation in an optimal temperature zone and individual home delivery in an optimal temperature zone.

In each of the above examples, the container 11 includes the recording unit 15. This is a desirable configuration, but is not essential. In the case where the container 11 does not include the recording unit 15, the recognition unit 14 such as a camera may directly recognize goods in the container 11, and the control unit 17 may determine a desirable environmental range based on the recognition results (by referring to a server etc., if necessary). In this case, the contents of the container 11 are the attributes of the container 11. The attributes may be directly recorded on the contents of the container 11 using a QR code, an RF tag, etc., and the recognition unit 14 may recognize the attributes.

These configurations may be combined. For example, the types of goods may be read from the recording unit 15, the amount of goods may be measured, and a desirable environmental range may be determined based on the combination of the read types of goods and the measured amount of goods.

<Others>

The examples in which the environmental control system 10 is mounted on the vehicle 18 are mainly described above. However, it is not essential for the environmental control system 10 to be mounted on the vehicle 18. The environmental control system 10 may be installed at a specific location. For example, the environmental control system of the present disclosure may be used as a delivery box provided in an apartment house. In the case where the environmental control system of the present disclosure is used for both the vehicle and the delivery box, a similar environmental range can be maintained when the container 11 is transferred from the vehicle to the delivery box. Alternatively, the environmental control system 10 may be installed as, e.g., a delivery locker at a train station or may be installed in a warehouse or a distribution center. The environmental control system 10 may be stationary, or the entire shelf 12 loaded with one or more containers 11 may be transported on lanes of the distribution center and delivered to a warehouse, a distribution center, or a vehicle. The container 11 can also be collected and used multiple times. In the case of the system mounted on a vehicle, the contents of the delivered container 11 may be replaced at the delivery destination of the completed container 11. Alternatively, other prepared containers 11 having their contents placed therein in advance may be loaded at the delivery destination of the completed container 11 and transported to other delivery base or other delivery destination. Empty spaces in the shelf 12 can thus be used. The delivery destination to which a package is delivered may be, e.g., a private home or a store such as a convenience store. A pickup location where a package is picked up may also be, e.g., a private house or a store such as a convenience store. It is therefore possible to effectively use what is called venous physical distribution. In this case as well, the environmental range can be controlled for each container 11. This system is therefore more efficient than in the case where the entire vehicle is controlled to the freezing temperature, refrigerating temperature, etc.

An empty space in the shelf 12 may be reserved via the external server 44. An empty space can thus be preferentially secured for a specific package to be picked up at a delivery base or a private home or a shop which is a delivery destination. This eliminates the problem that the empty spaces of the shelf 12 run short due to other packages having been picked up. After delivery is completed at the delivery destination of the container 11, the vehicle with a reserved empty space heads to the pickup location to pick up a package for the reserved empty space. Packages are thus reliably and efficiently picked up. In consideration of the reservation, an additional fee may be collected in addition to a delivery fee from the user or store who reserved an empty space.

As long as the information on transportation is stored as the attributes of the container 11, the external server 44 can keep track of the availability of the shelf 12 in each vehicle, the amount and type of delivery for each location. The shelf 12 can also be used efficiently. Containers of a plurality of sizes may be prepared and may be placed across the columns or rows of the shelf 12. For example, a container of twice the size of a normal container 11 may be used and placed in an area in the shelf 12 which is large enough to hold two normal containers 11. Containers of different sizes corresponding to a plurality of areas in the shelf 12 can thus be used, so that packages can be more flexibly and more efficiently delivered.

The contents of the embodiment and other contents such as supplements described in the specification may be carried out in combination.

A program for the environmental control system 10 to perform a method for environmental control based on attributes may be stored in advance in a read only memory (ROM), a random access memory (RAM), a recording medium, etc., and may be run by a processor. As described in each example of the embodiment, the ROM and a central processing unit (CPU) may be provided in the environmental control system 10 or may be provided externally and controlled by communication.

The recognition unit, the communication unit, the control unit, etc. in each example of the embodiment may be typically implemented as circuits having an input terminal and an output terminal, such as large scale integration (LSI) and field-programmable gate array (FPGA). Each of these circuits may be individually implemented in one chip, or these circuits may be implemented in one chip that include all or part of the configurations of each example of the embodiment.

An integrated circuit and a processor may be configured to download all or part of software that is necessary to implement the control method and/or the communication method described in the present disclosure by wireless communication or wired communication. The integrated circuit and the processor may be configured to download all or part of updating software by wireless communication or wired communication. The digital signal processing described in the present disclosure may be performed by storing the downloaded software in a storage unit and operating the integrated circuit and the processor based on the stored software.

In this case, a device including the integrated circuit and the processor may be connected to a communication modem wirelessly or by wire, and the communication method described in the present disclosure may be implemented by the device and the communication modem.

### INDUSTRIAL APPLICABILITY

Since the environmental control system of the present disclosure controls the environmental range according to the attributes of each accommodated container, the environmental control system of the present disclosure is useful for vehicles etc. that transport goods that are sensitive to the transportation environment such as food and medicines.

### DESCRIPTION OF REFERENCE CHARACTERS

10 Environmental Control System
11 Container
11a to 11e Container
12 Shelf
13 Air Flow Path
13a Cooling Flow Path
13b Return Flow Path
14 Recognition Unit
15 Recording Unit
16 Refrigerator
17 Control Unit
18 Vehicle
21 Compressor
22 Refrigerant Pipe
23 Condenser
24 Evaporator
25 Fan
31, 31a Platform Portion
32 Top Portion
36 Opening and Closing Plate
37, 37a Inlet Hole
38, 38a Outlet Hole
39 Foodstuffs
41 Determination Unit
42 Transmission Unit
43 Reception Unit
44 External Server

1. An environmental control system, comprising:
a plurality of containers that stores goods;
a shelf that is transported by a vehicle and accommodates the plurality of containers;
an environmental adjustment facility that adjusts an environment in each container; and
a control unit that controls the environmental adjustment facility so that the environment in the container is adjusted to a predetermined environmental range based on an attribute set for each container, wherein
an empty space in the shelf on the vehicle is kept track of based on information on transportation of each container.

2. The environmental control system of claim 1, further comprising:
a recognition unit that recognizes the attribute of each container; and
a determination unit that determines the environmental range to which the corresponding container is to be adjusted by the environmental adjustment facility, based on the attribute recognized by the recognition unit.

3. The environmental control system of claim 1, further comprising:
a recognition unit that recognizes the attribute of each container;
a transmission unit that sends the attribute recognized by the recognition unit to outside; and
a reception unit that receives from the outside the environmental range determined based on the sent attribute to which the corresponding container is to be adjusted by the environmental adjustment facility.

4. The environmental control system of claim 1, further comprising:
a reception unit that receives the attribute of each container from outside; and
a determination unit that determines the environmental range to which the corresponding container is adjusted by the environmental adjustment facility, based on the attribute received by the reception unit.

5. The environmental control system of claim 1, further comprising:
a reception unit that receives from outside the environmental range determined based on the attribute to which the corresponding container is to be adjusted by the environmental adjustment facility.

6. The environmental control system of claim 1, wherein
the container includes a recording unit that holds the attribute of the container, and
the attribute includes at least one of description of goods that are placed in the corresponding container, the environmental range to which the corresponding container is to be adjusted, a unique identification number of the corresponding container, a temporary identification number of the corresponding container, and information on transportation of the corresponding container.

7. The environmental control system of claim 1, wherein
the environmental adjustment facility includes a medium flow path which is provided in the shelf and through which a medium flows, and a contact adjustment unit that adjust a degree of contact between each container and the medium.

8. The environmental control system of claim 7, wherein
the medium is air, and the air is able to return to the medium flow path after entering the container from the medium flow path, and
the contact adjustment unit is a damper that adjusts a flow rate of the air that is the medium flowing in the container.

9. The environmental control system of claim 7, wherein
the environmental adjustment facility further includes a circulation unit that circulates the medium in the medium flow path, and a medium temperature holding unit that holds the medium at a predetermined temperature.

10. The environmental control system of claim 1, wherein
the container is a thermally insulating container.

11. A container that is used in the environmental control system of claim 1.

12. A method for operating an environmental control system including a plurality of containers that stores goods, a shelf that is transported by a vehicle and accommodates the plurality of containers, and an environmental adjustment facility that adjusts an environment in each container, comprising:
controlling the environmental adjustment facility by a control unit so that the environment in the container is adjusted to a predetermined environmental range based on an attribute set for each container; and
keeping track of an empty space in the shelf on the vehicle based on information on transportation of each container.

13. The method of claim 12, further comprising:
recognizing the attribute of each container by a recognition unit; and
determining the environmental range for the corresponding container by a determination unit based on the attribute recognized by the recognition unit.

14. The method of claim 12, further comprising:
recognizing the attribute of each container by a recognizing unit;
sending the attribute recognized by the recognition unit to outside by a transmission unit; and
receiving from the outside by a reception unit the environmental range determined based on the sent attribute to which the corresponding container is to be adjusted by the environmental adjustment facility.

15. The method of claim 12, further comprising:
receiving the attribute of each container by a reception unit; and
determining the environmental range for the corresponding container by a determination unit based on the attribute received by the reception unit.

16. The method of claim 12, further comprising:
receiving from outside by a reception unit the environmental range determined based on the attribute of the container to which the corresponding container is to be adjusted by the environmental adjustment facility.

17. The method of claim 12, further comprising:
holding the attribute of the container in a recording unit of the container.

18. The environmental control system of claim 1, wherein
the empty space in the shelf on the vehicle is reservable.

19. A vehicle that is used in the environmental control system of claim 1.

20. The method of claim 12, further comprising:
reserving the empty space in the shelf on the vehicle.
